(19) United States
(12) Patent Application Publication
(10) Pub. No.: US 2013/0071533 A1
(43) Pub. Date: Mar. 21, 2013

(54) METHOD OF MAKING A FOOD PRODUCT AND A FOOD PRODUCT MADE BY THE METHOD

(71) Applicant: Raymond RASTELLI, Mullica Hill, NJ (US)

(72) Inventor: Raymond RASTELLI, Mullica Hill, NJ (US)

(73) Assignee: RASTELLI FOODS GROUP, Swedesboro, NJ (US)

(21) Appl. No.: 13/615,823

(22) Filed: Sep. 14, 2012

Related U.S. Application Data
(60) Provisional application No. 61/536,742, filed on Sep. 20, 2011.

(51) Int. Cl. A22C 21/00; A23L 1/315; A22C 17/00

(52) U.S. Cl. 426/480; 452/149; 452/125; 452/135

(57) ABSTRACT

A method is provided for making a food product from a drumstick having a first end including a portion of a thigh joint, a second end including a portion of a foot joint, a bone extending between the first and second ends and meat surrounding at least a portion of the bone. The method includes making a first cut completely through the drumstick generally perpendicular to the bone and at least a first predetermined distance from the first end to remove the first end and making a second cut completely through the drumstick generally perpendicular to the bone and at least a second predetermined distance from the second end to remove the second end. The remaining mid-portion of the drumstick is a food product including most of the meat of the drumstick surrounding a remaining portion of the bone.

### CROSS REFERENCE TO RELATED APPLICATIONS

This application claims the benefit of U.S. provisional application No. 61/536,742 filed Sep. 20, 2011 and entitled “Apparatus and Method of Preparing Foodstuff for Human Consumption” the subject matter of which is hereby incorporated herein by reference.

### BACKGROUND OF THE INVENTION

The present invention relates generally to a method of preparing foodstuff and, more particularly, to a method of cutting or trimming both ends of a drumstick of a bird or other meat leg, such that any tendons, joints, cartilage or other inedible components therein are severed from any central bone therein to allow a consumer to more easily consume the remaining drumstick or other meat and to provide a unique and aesthetically pleasing food product.

The meat and poultry industry is one of the largest, if not the largest, segment of the United States' (U.S.) agricultural sector. According to the American Meat Industry, an American male on average eats 6.9 ounces of meat per day, and an American female on average eats 4.4 ounces of meat per day. The total meat and poultry production in 2010 in the U.S. reached more than 92.1 billion pounds, which was up 1.2 billion pounds from 2009.

One of the meatiest parts of a bird includes the walking muscles on the first and second segments of the legs, called the thigh and drumstick, respectively. A drumstick generally has a first end proximate the thigh and a second or foot end or a hock, which is the anatomical homologue of the ankle of a human foot.

Given the high consumption of meat in the U.S., it is advantageous to make as much of the meat on a drumstick available to a consumer as possible, in a manner which is convenient and aesthetically pleasing to the consumer. Typically, because of the structure of a drumstick, it can be difficult for a consumer to easily remove and eat most or all of the meat from the drumstick bone. Furthermore, some individuals find drumsticks to be aesthetically unpleasing. These individuals are much less inclined to eat the meat on a drumstick, as compared to other, more consumer friendly parts of the bird, such as the breast meat.

Therefore, it would be desirable to provide an apparatus and method of preparing foodstuff, and in particular a drumstick of a bird, that allows a user to more easily access and consume most or all of the drumstick meat with little or no waste. In particular, it would be desirable to quickly and easily sever and remove the tendons, joints, cartilage and other inedible components from each end of a drumstick such that the remaining meat can be more easily removed from the bone for consumption with minimal waste. Furthermore, it would be desirable to provide a drumstick product which is ready for consumption, and having an aesthetically pleasing and unique appearance to encourage consumers to eat more drumsticks. Such an apparatus and method would provide added value to a conventional drumstick. The present invention accomplishes the above objectives.

### BRIEF SUMMARY OF THE INVENTION

Briefly stated, in one aspect, the present invention comprises a method of making a food product from a drumstick of a bird, the drumstick having a first end including at least a portion of a thigh joint, cartilage, tendons and other inedible components, a second end including at least a portion of a foot joint, cartilage, tendons and other inedible components, a bone extending longitudinally between the first and second ends and meat surrounding at least a portion of the bone. The method comprises the steps of: making a first cut completely through the drumstick generally perpendicular to the bone and at least a first predetermined distance from the first end to remove the first end from a mid-portion of the drumstick; and making a second cut completely through the drumstick generally perpendicular to the bone and at least a second predetermined distance from the second end to remove the second end from the mid-portion of the drumstick, the mid-portion being a food product comprising most of the meat of the drumstick surrounding a remaining portion of the bone.

In another aspect, the present invention comprises a method of making a food product from a foodstuff, the foodstuff having a first end including at least a portion of a first joint, cartilage, tendons and other inedible components, a second end including at least a portion of a second joint, cartilage, tendons and other inedible components, a bone extending longitudinally between the first and second ends and meat surrounding at least a portion of the bone. The method comprises the steps of: making a first cut completely through the foodstuff generally perpendicular to the bone and at least a first predetermined distance from the first end to remove the first end from a mid-portion of the foodstuff; and making a second cut completely through the foodstuff generally perpendicular to the bone and at least a second predetermined distance from the second end to remove the second end from the mid-portion of the foodstuff, the mid-portion being a food product comprising the meat of the foodstuff surrounding a remaining portion of the bone.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a typical chicken drumstick (foodstuff) in an initial or untrimmed state;

FIG. 2 is a perspective view of the drumstick of FIG. 1 after being trimmed in accordance with a preferred embodiment of the present invention;

FIG. 3 is an enlarged perspective view of a portion of the trimmed drumstick of FIG. 2;

FIG. 4 is an enlarged perspective view of an opposing portion of the trimmed drumstick of FIG. 2;

FIG. 5 is a perspective view of a portion of the trimmed drumstick of FIG. 2 in an uncooked state;

FIG. 6 is a perspective view of the portion of the trimmed drumstick of FIG. 5 in a cooked state;

FIG. 7 is a perspective view of a preferred embodiment of an apparatus for trimming drumsticks in accordance with the present invention;

FIG. 8 is a front elevational view of the apparatus of FIG. 7;

FIG. 9 is a top plan view of the apparatus of FIG. 7;

FIG. 10 is a side elevational view of the apparatus of FIG. 7;

FIG. 10A is an enlarged partial side elevational view of the apparatus of FIG. 7, taken from a portion of FIG. 10; and

FIG. 11 is an enlarged perspective view of a portion of the apparatus of FIG. 7 supporting a drumstick to be trimmed.

### DETAILED DESCRIPTION OF THE INVENTION

Certain terminology is used in the following description for convenience only and is not limiting. The word and “outwardly” refers to a direction away from the geometric center of the drumstick or foodstuff, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

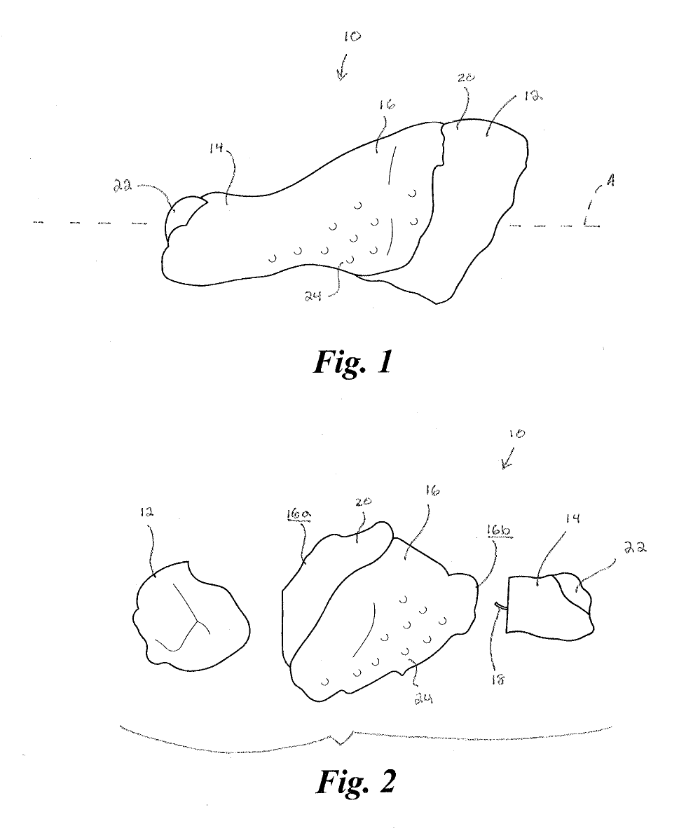

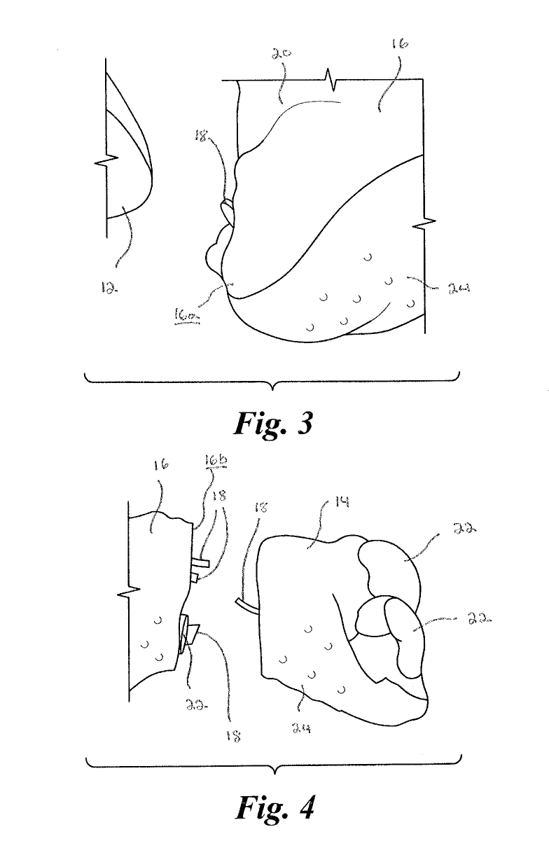

Referring to the drawings in detail, wherein like numerals indicate like elements throughout, FIGS. 1-6 show a preferred embodiment of a foodstuff, generally designated 10, for consumption by a consumer. In the present preferred embodiment and as shown in the drawings, the foodstuff 10 is a drumstick of a bird, such as chicken, some other poultry, fowl or the like. However, the foodstuff 10 described herein as a chicken drumstick may also be any other suitable meat item, such as beef, pork, lamb, etc., that can be prepared for safe consumption by humans, and particularly the leg of any such meat item that is attached to or at least partially surrounds a bone. Accordingly, it will be clearly understood that the below description of a chicken drumstick 10 should not be considered a limitation on the present invention.

Referring to FIG. 1, the generally untrimmed drumstick 10, in its initial state includes a first or thigh end 12, an opposing second, foot or hock end 14, and a mid-portion 16 therebetween which includes the majority of the edible meat 20. It is preferred that the drumstick 10 is a commodity drumstick of the type sold by the North American Meat Processors Association (NAMP), such as that identified by product number P1035.

As shown in FIG. 2, in the first step of the present method it is preferred that the uncooked or at least generally raw drumstick 10 is selectively trimmed by making a first cut completely through the drumstick 10 generally perpendicular to the bone 22 at least a first predetermined distance from the first end 12, such that the first end 12, including the thigh joint and all associated skin, cartilage, fat, tendons and other inedible components is completely severed or separated from the mid-portion 16 to expose a first surface 16a thereof. The first predetermined distance is at least slightly beyond (toward the mid-portion 16) the position where the bone 22 engages the thigh joint so that when the first cut is made the entire thigh joint and all other associated inedible components are completely removed from the mid-portion 16. It is also preferred as a second step of the present method that the uncooked or at least generally raw drumstick 10 is selectively trimmed by making a second cut completely through the drumstick 10 generally perpendicular to the bone 22 at least a second predetermined distance from the second end 14, such that the second end 14, including the foot joint and all associated skin, cartilage, fat, tendons and other inedible components is completely severed or separated from the mid-portion 16 to expose an opposing second surface 16b. The second predetermined distance is at least slightly beyond (toward the mid-portion 16) the position where the bone 22 engages the foot joint so that when the second cut is made the entire foot joint and all other associated inedible components are completely removed from the mid-portion 16. Any suitable cutting device, apparatus or means may be used to make the first and second cuts and sever or separate the ends 12, 14 from the mid-portion 16, such as a conventional knife, water knife, saw or the like, that is operated manually or automatically. In addition, the first and second cuts may be made in any desired order or simultaneously (see below), if desired. The first and second predetermined distances will vary depending on the size of the drumstick 10 and the sizes of the thigh and foot joints. The first and second cuts result in the mid-portion 16 as a new drumstick food product.

Each of the first end 12, the second end 14, and the mid-portion 16 of the drumstick 10 may include meat 20 suitable for consumption by humans. The mid-portion 16 of the drumstick 10 typically includes substantially more meat 20 than that of both the first end 12 and the second end 14 combined and typically includes most of the edible drumstick meat 20. Therefore, it is preferred that the method of cutting a drumstick 10 as described herein is focused on preserving and preparing at least the mid-portion 16 of the drumstick 10 for quick and efficient consumption. However, the method of cutting the drumstick 10 described herein is not limited to a drumstick 10 having more meat 20 concentrated at the mid-portion 16 thereof. All or portions of the meat 20 may be surrounded or covered by skin 24.

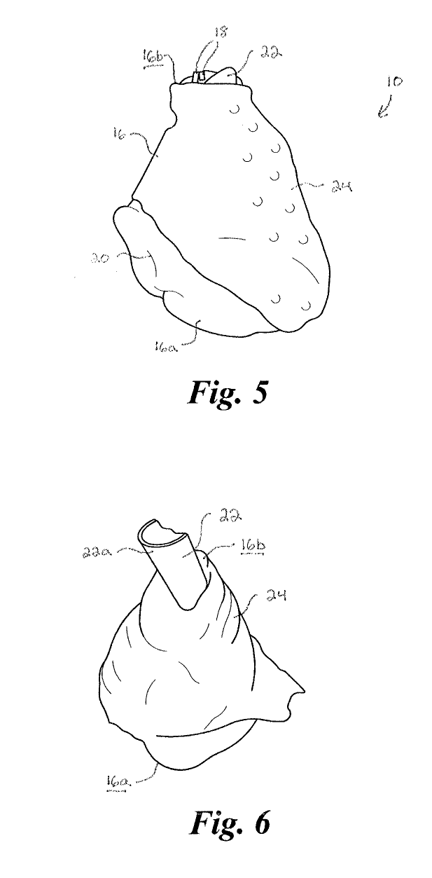

Cutting or severing the first end 12 from the mid-portion 16 of the drumstick 10 allows the mid-portion 16 to stand generally self-supported in a generally vertical orientation (see FIGS. 5 and 6) on the first surface 16a. Cutting or severing the second end 14 from the mid-portion 16 of the drumstick 10 preferably completely severs or cuts through one or more tendons 18 of the drumstick 10 and preferably at least partially exposes at least a small portion of the centrally located bone 22 of the drumstick 10. The tendons 18 typically attach at least portions of the meat 20 to the bone 22, particularly near the thigh joint in the in the first end 12 and near the foot joint in the second end 14 of the drumstick 10 prior to severing or cutting of the first and second ends 12, 14. Completely severing the tendons 18 allows the remaining meat 20 of the mid-portion 16 to be relatively quickly and easily separated from the bone 22 during consumption. It is preferred that the severing or cutting of the tendons 18 is accomplished before cooking or heating of the mid-portion 16, but this step may be accomplished after or even during cooking or heating of the mid-portion 16. The skin 24 which surrounds the meat 20 may be removed either prior to or after cooking or heating if desired or may remain on the meat 20.

It is preferred that the drumstick 10 is cut to remove the first and second ends 12,14 while in a generally horizontal orientation (see FIGS. 1 and 2), such that a longitudinal axis A of the drumstick 10 extends generally parallel to a support surface, such as a table or countertop (not shown). However, if desired, the drumstick 10 may be cut while in a generally vertical orientation (see FIGS. 5 and 6), such that the longitudinal axis A of the drumstick 10 extends generally perpendicularly to the support surface.

Once the drumstick 10 is cut as described above to provide the separate mid-portion 16, the generally raw or uncooked mid-portion 16 preferably appears generally as shown in FIG. 5. The mid-portion 16 may be placed or sat in a generally vertical orientation, such that the first surface 16a of the mid-portion 16 is down and rests directly on or against the support surface. Further, in this orientation, the meat 20 of the mid-portion 16 generally rests against or is supported internally by the bone 22, which also extends in a generally vertical orientation. The mid-portion 16 may be cooked in either the vertical or horizontal orientation, and the finished, cooked mid-portion 16 appears generally as shown in FIG. 6.

Cooking the generally raw, trimmed mid-portion 16 in the generally vertical orientation as shown in FIG. 5, preferably exposes as least a portion of the upper or proximal end 22a of the bone 22 or increases the proximal portion 22a of the bone 22 which is exposed, so as to generally form a handle for gripping by at least a portion of a consumer's hand. In other words, during the cooking or heating process, the meat 20 of the foodstuff 10 preferably shrinks, moves or slides at least slightly down or away from the proximal end 22a of the bone 22 toward the first surface 16a, as shown when comparing FIGS. 5 and 6. The exposed proximal end 22a of the bone 22 is then capable of functioning as a handle for use by the consumer in consuming the meat 20 of the mid-portion 16.

It is preferred that the mid-portion 16 is placed in the vertical orientation (FIG. 6) prior to consumption by the consumer (i.e., on a serving dish). The handle formed by the exposed upper or proximal portion 22a of the bone 22 allows the consumer to selectively grasp and manipulate the trimmed mid-portion 16 to consume at least some of the meat 20, and the above-described trimming and/or cooking process allows the meat 20 to be relatively easily removed from the bone 22 during consumption. In other words, although any connection between the meat 20 and the bone 22 of the mid-portion 16 is intentionally weakened by the above-described trimming and/or cooking process, the bone 22 can still function as a tool to help the consumer more easily consume the meat 20. Alternatively, the bone 22 and any remaining tendons 18 or portions thereof may be relatively easily removed from the meat 20 by simply pulling generally upwardly on the proximal end 22a (FIG. 6) of the bone 22 until the distal end (not shown) of the bone 22 and any remaining tendons 18 or portions thereof are entirely removed from the meat 20 leaving a substantially boneless meat product (not shown). The finished, cooked mid-portion 16 as shown in FIG. 6 is tender and juicy and has a generally aesthetically-pleasing, gourmet appearance. Further, the finished, cooked mid-portion 16 preferably does not resemble or only somewhat resembles a conventional drumstick 10 in appearance, as typically presented at a restaurant or during a home meal.

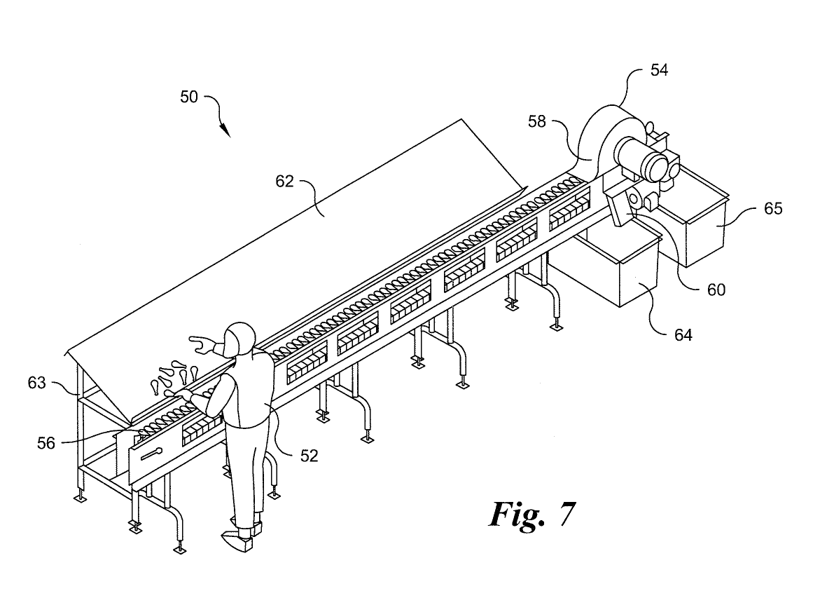

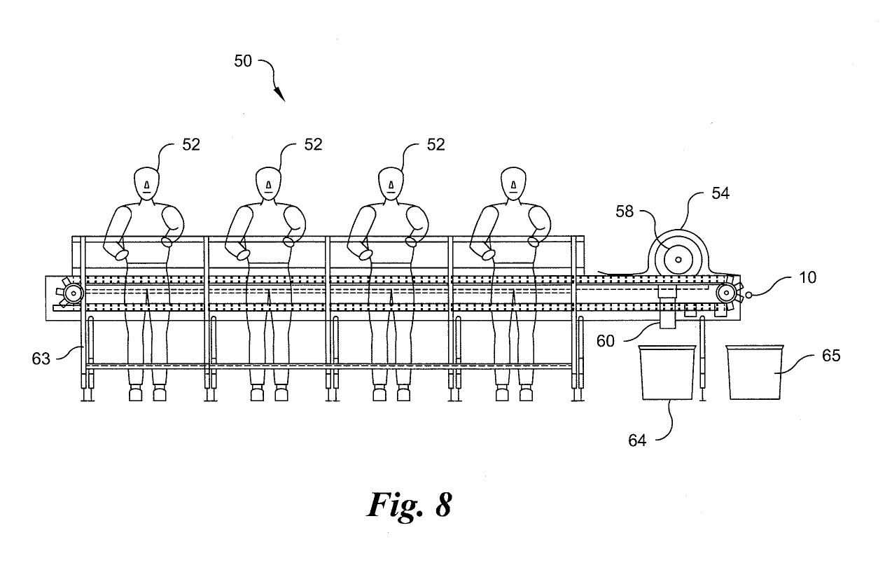

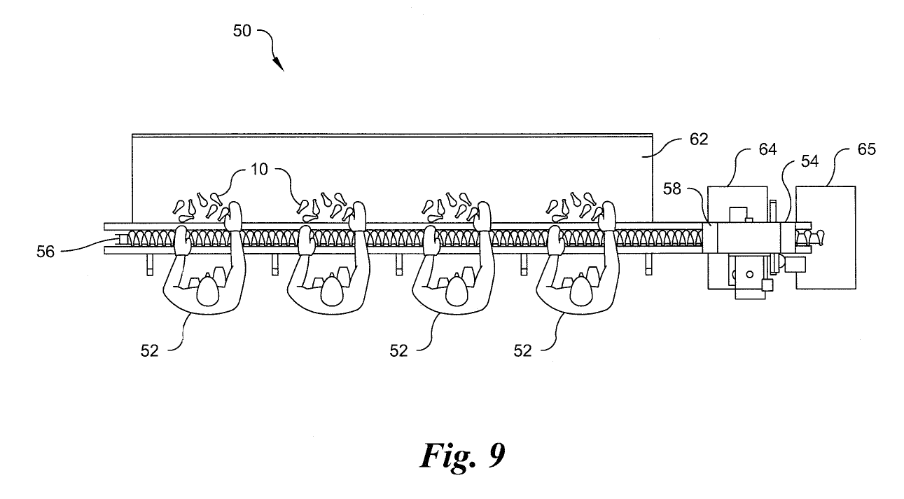

FIGS. 7-11 show a preferred embodiment of an apparatus, generally designated 50, and a method of preparing drumsticks 10 as described above. The apparatus 50 preferably allows multiple individuals 52 to simultaneously prepare multiple drumsticks 10, as described above with respect to FIGS. 1-6. However, a single individual 52 may operate the apparatus 50 to prepare drumsticks 10, as shown in FIG. 7 and as discussed above. The apparatus 50 preferably at least partially automates the method described above.

In the preferred embodiment, the apparatus 50 includes a motor 54 that operates a preferably chain-driven conveyor 56 in a rotatable manner, a cutting system, generally designated 58, and a dispenser 60. The cutting system 58 preferably includes two generally circular, rotating, generally parallel, laterally spaced-apart cutting blades (not shown) for directly engaging and cutting drumsticks 10. However, the cutting system 58 may include only a single blade or knife, or more than two blades or knives. The blades are preferably sized and shaped to generally fit within an outer housing or cover of the cutting system 58, so as to protect the individual(s) 52 from accidental or inadvertent contact with the blades. The lateral spacing between the blades may be selectively modified or adjusted, either manually or automatically, to adapt to the size of various drumsticks 10. For example, the spacing between the blades would be greater for cutting larger drumsticks, such as from a turkey and lesser for cutting smaller drumsticks, such as from a chicken or game hen.

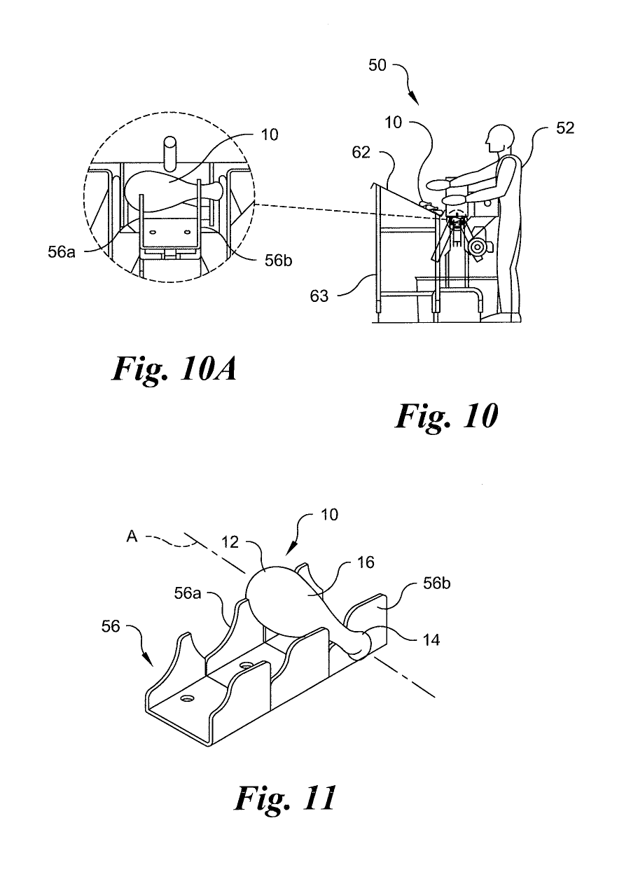

The apparatus 50 also preferably includes a sorting table 62 to facilitate placement of unprocessed or uncooked drumsticks 10 in an ergonomic position for convenient access by the operator(s) or individual(s) 52. The sorting table 62 is preferably set at an incline or angle with respect to the ground (see FIGS. 7 and 10), is preferably formed of stainless steel (or some other preferably food-grade material), and is preferably twelve feet (12′) long so as to extend generally an entire length of the conveyor 56. The preferably planar sorting table 62 is preferably supported about the ground by a frame 63. The entire apparatus 50 preferably is approximately seventeen feet (17′) long.

As shown in FIG. 10A and 11, the conveyor 56 preferably receives a plurality of individual drumsticks 10 in a side-by-side orientation. When each of the drumsticks 10 is properly positioned within the conveyor 56, opposing portions of the drumsticks 10 extend laterally outwardly beyond opposing sidewalls 56a and 56b of the conveyor 56. In addition, it is preferred that the longitudinal axis A of each drumstick 10 extends generally perpendicularly to a longitudinal axis of the conveyor 56 (see FIG. 11). The motor 54 may include two distinct portions, such that the conveyor 56 is driven by a 0.33 HP motor, for example, with a stainless steel gear box and the cutting system 58 is driven by a 3 HP motor, for example. The apparatus 50 is preferably designed to process or trim thirty-forty thousand drumsticks 10 per day.

In operation, it is preferred that multiple drumsticks 10 are placed on the sorting table 62 and at least one individual 52 stands as shown in FIGS. 7-10. Once the motor 54 begins to operate, the conveyor 56 preferably rotates in a generally clockwise configuration from the perspective of the operator 52 in FIG. 7. The operator 52 preferably places or makes sure that each drumstick 10 is placed as shown in FIGS. 10A and 11, such that each drumstick 10 is supported on the conveyor 56 so that the first end 12 extends laterally outwardly beyond one sidewall 56a of the conveyor 56 and the second end 14 extends laterally outwardly beyond an opposing sidewall 56b of the conveyor 56. The blades of the cutting system 58 are preferably at least slightly laterally-spaced from the sidewalls 56a, 56b of the conveyor 56, so that the blades do not contact the sidewalls 56a, 56b. The conveyor 56 preferably moves each drumstick 10 toward the cutting system 58. Once a drumstick 10 reaches the cutting system 58, the blades within the cutting system 58 completely sever or trim the first and second ends 12, 14 from the mid-portion 16 of the drumstick 10, as described above in connection with FIGS. 1-6.

Once the cutting has occurred, it is preferred that the trimmed mid-section 16 of each drumstick 10 continues on the conveyor 56 until the conveyor 56 begins to rotate back toward the operator 52. At this point, the separated mid-portion 16 preferably falls from the conveyor 56 or is placed into a first bin 65, for example. The separated first and second ends 12, 14 of each trimmed drumstick 10 preferably fall into or are temporarily place or disposed of in a second bin 64, for example, through the dispenser 60. The separated first and second ends 12, 14 may be used for many purposes, such making stock for soups or sauces, for example, or other items for human consumption, and/or for feed, rendering and/or boned for grinding, for example. The apparatus 50 may include one dispenser 60 on each lateral side thereof, so that the separated first end 12 of each drumstick 10 may travel through one dispenser 60, and the separated second end 14 of each drumstick 10 may travel through the other dispenser 60.

It will be appreciated by those skilled in the art that changes could be made to the embodiments described above without departing from the broad inventive concept thereof. For example, some other type of bird, such as a turkey, or some other type of meat, such as pork could be used to make a meat product in accordance with the method of the present invention. It is understood, therefore, that this invention is not limited to the particular embodiments disclosed, but it is intended to cover modifications within the spirit and scope of the present invention as defined by the appended claims.

I/we claim:

1. A method of making a food product from a drumstick of a bird, the drumstick having a first end including at least a portion of a thigh joint, cartilage, tendons and other inedible components, a second end including at least a portion of a foot joint, cartilage, tendons and other inedible components, a bone extending longitudinally between the first and second ends and meat surrounding at least a portion of the bone, the method comprising:
making a first cut completely through the drumstick generally perpendicular to the bone and at least a first predetermined distance from the first end to remove the first end from a mid-portion of the drumstick; and
making a second cut completely through the drumstick generally perpendicular to the bone and at least a second predetermined distance from the second end to remove the second end from the mid-portion of the drumstick, the mid-portion being a food product comprising most of the meat of the drumstick surrounding a remaining portion of the bone.

2. The method as recited in claim 1 further comprising the step of cooking the mid-portion product in a generally vertical orientation such that a first end of the mid-portion extends generally downwardly and a second end of the mid-portion extending generally upwardly, the cooking resulting in the meat proximate to the second end of the mid-portion moving away from the bone to expose at least a portion of the bone which serves as a handle to permit a consumer to pick up the mid-portion for consumption of the meat.

3. The method as recited in claim 2 further comprising the step of removing the remaining portion of the bone from the mid-portion after the cooking step.

4. The method as recited in claim 1 wherein the first predetermined distance is at least slightly beyond the position at which the bone engages the thigh joint and the second predetermined distance is at least slightly beyond the position at which the bone engages the foot joint.

5. The method as recited in claim 1 wherein the first and second cuts are made simultaneously.

6. The method as recited in claim 1 wherein the first and second cuts are made using one of a knife, a water knife and a saw blade.

7. The method as recited in claim 1 wherein the drumstick includes skin and further including the step of removing the skin from at least the mid-portion.

8. The method as recited in claim 1 further comprising the step of removing the remaining portion of the bone from the mid-portion after making the first and second cuts.

9. The method as recited in claim 1 wherein the bird is a chicken and the drumstick is a chicken drumstick.

10. A food product made in accordance with the method of claim 1.

11. A method of making a food product from a foodstuff, the foodstuff having a first end including at least a portion of a first joint, cartilage, tendons and other inedible components, a second end including at least a portion of a second joint, cartilage, tendons and other inedible components, a bone extending longitudinally between the first and second ends and meat surrounding at least a portion of the bone, the method comprising:
making a first cut completely through the foodstuff generally perpendicular to the bone and at least a first predetermined distance from the first end to remove the first end from a mid-portion of the foodstuff; and
making a second cut completely through the foodstuff generally perpendicular to the bone and at least a second predetermined distance from the second end to remove the second end from the mid-portion of the foodstuff, the mid-portion being a food product comprising the meat of the foodstuff surrounding a remaining portion of the bone.

12. The method as recited in claim 11 further comprising the step of cooking the mid-portion product in an orientation such that a first end of the mid-portion extends generally downwardly and a second end of the mid-portion extending generally upwardly, the cooking resulting in the meat proximate to the second end of the mid-portion moving away from the bone to expose at least a portion of the bone which serves as a handle to permit a consumer to pick up the mid-portion for consumption of the meat.

13. The method as recited in claim 11 wherein the first predetermined distance is at least slightly beyond the position at which the bone engages the first joint and the second predetermined distance is at least slightly beyond the position at which the bone engages the second joint.

14. The method as recited in claim 11 wherein the first and second cuts are made simultaneously.

15. A food product made in accordance with the method of claim 11.
